(19) United States
(12) Patent Application Publication
(10) Pub. No.: US 2025/0268780 A1
(43) Pub. Date: Aug. 28, 2025

(54) AUTONOMOUS POD SYSTEM

(71) Applicant: Jeff DAME, North Ogden, UT (US)

(72) Inventor: Jeff DAME, North Ogden, UT (US)

(21) Appl. No.: 18/584,815

(22) Filed: Feb. 22, 2024

(51) Int. Cl. A61H 15/00; B25J 5/00; B25J 11/00

(52) U.S. Cl. CPC A61H 15/0078; B25J 5/007; B25J 11/008; A61H 2201/0157

(57) ABSTRACT

The present disclosure provides an autonomous pod system, as described below and defined in the accompanying claims. The autonomous pod system may include a body. The autonomous pod system may include an attachment that may couple with the body and contact a user object. The autonomous pod system may include a sensor that may determine a location of the body or the attachment.

### TECHNICAL FIELD

The technology disclosed herein relates generally to pods, and more specifically to autonomous pod systems that may be positioned on a user object to provide a sensory experience.

### BACKGROUND

Tools have been adapted for manipulation by a user to provide a sensory experience to the user. For example, tools such as a manual back scratcher require a user to grasp and move the tool in order to receive a sensory experience, and tools such as a foam roller require a user to move his or her body over the tool in order to receive a sensory experience.

Although there may be tools that may provide a sensory experience, a tool that may operate autonomously, e.g. without a user or other party manually maneuvering the tool to deliver the sensory experience, is needed.

The information included in this Background section of the specification is included for technical reference purposes only and is not to be regarded subject matter by which the scope of the present disclosure is to be bound.

### SUMMARY

The present disclosure provides an autonomous pod system. The autonomous pod system may include a body. The autonomous pod system may include an attachment that may couple with the body and contact a user object. The autonomous pod system may include a sensor that may determine a location of the body or the attachment.

In one example, the location may correspond to a position of the body or the attachment on the user object. The autonomous pod system may further include an adapter port defined by the body and the attachment may couple with the adapter port. The autonomous pod system may further include an adapter port defined by the body and the attachment may be a first attachment of a plurality of attachments and each attachment of the plurality of attachments may removably couple with the adapter port. The autonomous pod system may further include a propulsion system including a wheel and the wheel may include a plurality of ridges formed on an outer surface of the wheel. The autonomous pod system may further include a timer or a mode selector. The autonomous pod system may further include a sweeper that may couple with the body and the sweeper may contact the user object.

Examples of the present disclosure may include a system for delivering a sensory experience to a user or instigating a sensory experience of the user. The system may include a body that may translate on a user object. The system may include a plurality of interchangeable attachments and each attachment of the plurality of interchangeable attachments may removably couple with the body and contact the object when coupled with the body. The system may include a sensor that may determine a position of the body with respect to the user object. The system may further include a processor that may be in communication with the sensor and may translate the body from the first location to a second location based on the position of the body.

In one example, the system may further include an adapter port defined by the body and each attachment of the plurality of interchangeable attachments may removably couple with the adapter port. The system may further include a propulsion system that may couple with the body and may translate the body on the user object. The system may further include the propulsion system that includes a wheel. The wheel may include a plurality of ridges formed on an outer surface of the wheel. Each ridge of the plurality of ridges may extend circumferentially around the wheel. The system may further include a timer or a mode selector. The system may further include a sweeper that may couple with the body and may contact the user object.

Examples of the present disclosure may include an autonomous pod assembly. The autonomous pod assembly may include a body. The autonomous pod assembly may include an attachment that may couple with the body and may contact the user object. The autonomous pod assembly may include a plurality of wheels that may couple with the body and may translate the body on the user object. The autonomous pod assembly may include a sensor that may determine the location of the body on the user object.

The autonomous pod assembly may further include an adapter port defined by the body and the attachment may couple with the adapter port. The autonomous pod assembly may further include an adapter port defined by the body and the attachment may be a first attachment of a plurality of attachments. The plurality of attachments may each removably couple with the adapter port. In some examples, each wheel of the plurality of wheels may include a plurality of ridges formed on an outer surface of each wheel. The autonomous pod assembly may further include a timer or a mode selector. The autonomous pod assembly may further include a sweeper that may couple with the body and may contact the user object.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. A more extensive presentation of features, details, utilities, and some advantages of the present disclosure as defined in the claims is provided in the following written description of various examples of the claimed subject matter and illustrated in the accompanying drawings.

### BRIEF DESCRIPTION OF THE DRAWINGS

FIG. 1 is a top view of an autonomous pod system according to one example of the present disclosure.

FIG. 2 is a bottom view of the autonomous pod system in one example of the present disclosure.

FIG. 3 is a side view of the autonomous pod system in one example of the present disclosure.

FIG. 4 is a rear view of the autonomous pod system according to one example of the present disclosure.

FIG. 5 illustrates examples of attachments that may couple with a portion of the autonomous pod system.

FIG. 6A illustrates an example of a side view of a wheel of the autonomous pod system in one example of the present disclosure.

FIG. 6B illustrates an example of a front view of a wheel of the autonomous pod system in one example of the present disclosure.

FIG. 7A illustrates an example of the autonomous pod system in a first location in one example of the present disclosure.

FIG. 7B illustrates an example of the autonomous pod system in a second location in one example of the present disclosure.

FIG. 8 is a flowchart illustrating a method of operating the autonomous pod in one example of the present disclosure.

### DETAILED DESCRIPTION

The present disclosure generally relates to an autonomous pod system that may provide a sensory experience to a user. An individual may suffer from Post-Traumatic Stress Disorder (PTSD), episodes of which may include forcing the individual to re-live traumatic events, experience flashbacks, and/or experience vivid nightmares. The episodes may at least in part contribute to the individual developing or experiencing anxiety, stress, and/or panic. Sensory experiences may help relieve the effects and/or reduce the symptoms of PTSD. For example, sensory experience may help calm the user and may relieve the anxiety, stress, and/or panic attributable to PTSD. A sensory experience may occur in response to contacting a user object, such as a back of a user. The contact may include calming motions, for example, scratching, massaging, tickling, brushing, tapping, rubbing, stroking and the like.

Some tools that may provide a sensory experience require the user to maneuver the tool on the user object or maneuver the user object on the tool. It is beneficial to have a tool that may maneuver autonomously on the user object. For example, during an episode of PTSD the user may be incapable of maneuvering the tool on the user object or may be incapable of maneuvering the user object on the tool. In some instances, a user may be alone during an episode of PTSD and a tool that requires a second user to operate may not be an option or may not be realistic.

In one example, the autonomous pod system includes a body and at least one attachment that may couple with the body. At least a portion of the autonomous pod system may contact a user object and the contact may deliver, provide, or instigate a sensory experience. For example, the attachment may contact the user object. The system may further include a sensor that may determine a location of the body or the attachment. The sensor may facilitate the system to deliver a sensory experience and be structured such that the user may not be required to maneuver the tool. The system may traverse the user object and may deliver, provide, or instigate calming motions, for example, scratching, massaging, tickling, brushing, tapping, rubbing, stroking and the like, e.g., via the attachment. The system may be deployed during a PTSD episode and may provide relief to the user during the episode because the calming motions may be experienced by the user and the system may be structured such that the user may not be required to maneuver the tool, which may enhance the sensory experience. At least a portion of the system may be customizable, e.g. by a user or other party. For example, the user may select a mode or otherwise provide an instruction to the pod that corresponds to a type of motion, e.g., scratching, massaging, tickling, brushing, tapping, rubbing, stroking and the like, provided by the portion of the system while in contact with the user object. In this way, the sensory experience delivered to the user by the system may be customizable.

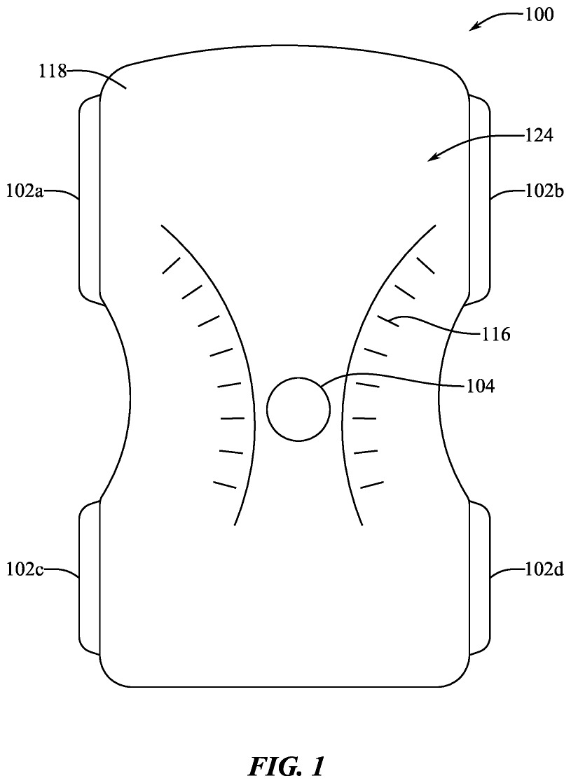

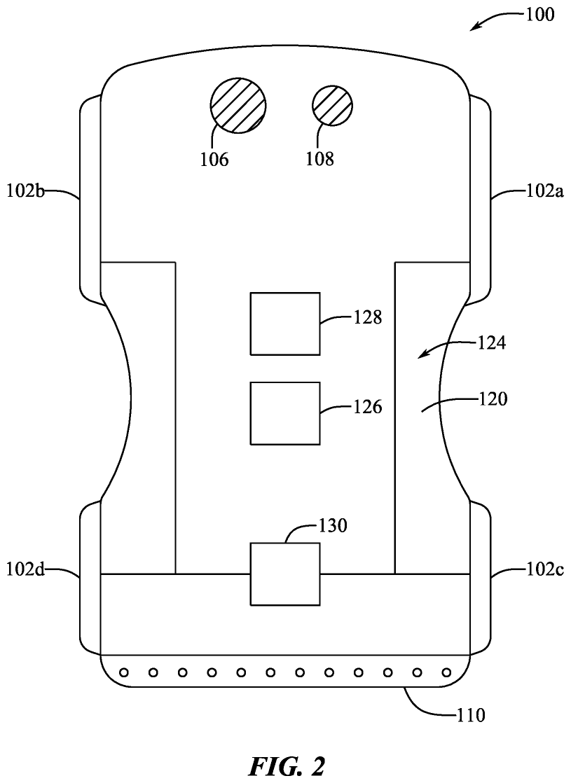

Turning to the figures, illustrative embodiments of the present disclosure with now be discussed in more detail. FIGS. 1 and 2 illustrate an example of a system 100. The system 100 may deliver or provide a sensory experience to a user. For example, the system 100 or a portion of the system 100 may contact the user and the user may sense, e.g., feel, the system 100 or a portion of the system 100. For example, the system 100 may activate, prompt, or instigate a sense of touch of the user. The system 100 may move or translate on or with respect to the user. The movement of the system 100 may at least partially contribute to the sensory experience deliver by the system 100. For example, the movement of the system 100 may enhance the sensory experience delivered to the user by the system 100. The system 100 may be autonomous, e.g., the system 100 may move on or with respect to the user without direct instruction or direction from the user during the movement of the system 100. For example, the user may select a mode, as discussed herein, and the system 100 may move corresponding to the mode, and in directions not directly chosen by the user at least during the movement of the system 100. For example, prior to the movement of the system 100, the user may select a predetermined path for the system 100 to follow during the movement of the system 100. In this way, the system 100 may be an autonomous pod system 100, an autonomous pod assembly 100, or an autonomous pod 100. In other examples, the system 100 may be remote-controlled. For example, the user may directly control the movement of the system 100, e.g., while the system 100 is in contact with the user. In this way the system 100 may be a pod system 100, a pod assembly 100, or a pod 100.

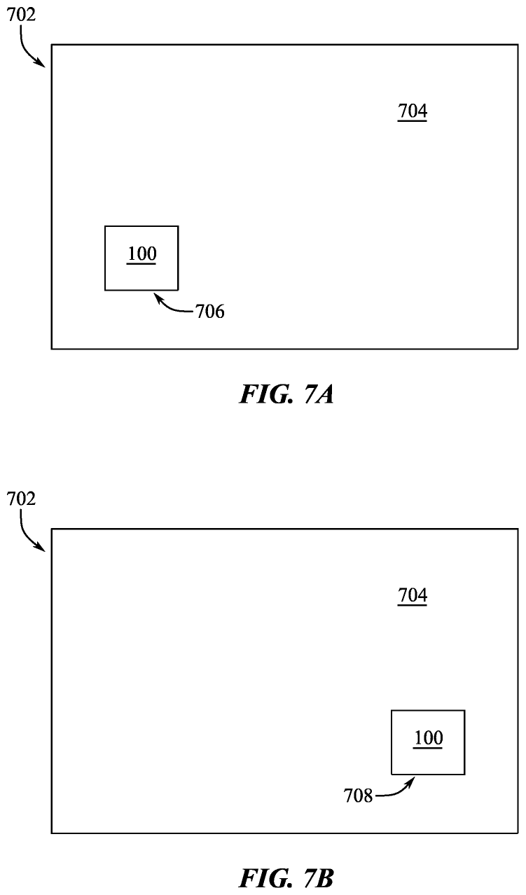

The system 100 may include at least one body 124. The body 124 may be defined by at least one surface, e.g., a first surface 118 and a second surface 120. The first surface 118 may define a contour shape of the body that, for example, may resemble a grip 116. For example, the grip 116 may be shaped to correspond to a hand that may facilitate or assist a user 702 or another to place the system 100 on a user object 704, such as a back of the user 702, as depicted in FIGS. 7A and 7B.

The system may include at least one power selector 104. For example, as depicted in FIG. 1, the first surface 118 may include the power selector 104. The power selector 104 may be or may include, at least one switch. For example, the switch may be or may include a pushbutton switch, a toggle switch, a rotary switch, a rocker switch, a latching button, and the like. The system 100 may include at least one mode selector 106. The system 100 may include at least one timer 108. For example as depicted in FIG. 2, the second surface 120 may include the mode selector 106 and the timer 108. The mode selector 106 may include at least one mode. For example, the mode selector 106 may include various speed modes, an oscillating mode, a scratching mode, a tapping mode, a rubbing mode, a tickling mode, and the like. The various modes of the mode selector 106 may be achieved or facilitated by at least one portion of the system 100, such as a sweeper 110 or an attachment 112, as discussed below. The system 100 may be customizable by the user 702. For example, the user 702 may be experiencing an episode of PTSD and a tapping mode may be calming and may relieve the PTSD symptoms. In another example, the user 702 may be experiencing anxiety and a scratching mode may be calming to relieve the PTSD symptoms for the user 702. In this way, the system 100 and the sensory experience delivered by the system 100 may be customizable, e.g., according to the needs of the user 702. The timer 108 may include at least one timer duration. For example, the timer 108 may include a 10-minute duration, a 15-minute duration, a 30-minute duration, an hour duration, and the like. For example, the user 702 may select a timer duration and the system 100 may provide a sensory experience for the duration of time selected by the user 702. In this way, the system 100 may by customizable and may provide a customizable sensory experience to the user 702, e.g, through the selection of a mode and a time duration.

The system 100 may include at least one propulsion system 130. In one example, the propulsion system 130 may include at least one wheel 102, e.g., a first wheel 102a, a second wheel 102b, a third wheel 102c, and a fourth wheel 102d. In another example, the propulsion system 130 may include at least one track. In yet another example, the propulsion system 130 may include a combination of wheels and tracks, or similar variations of wheel and track layouts. For example, the system 100 may include two wheels, which may enable a tighter turn radium of the system 100, compared to a system 100 with three wheels. In another example, the system 100 may include four wheels, which may enable or facilitate traction on the user object 704.

At least a portion of the propulsion system 130 may couple with or be in mechanical communication with the body 124. In this way, the propulsion system 130 may translate the body 124, e.g., on the user object 704. For example as depicted in FIGS. 7A and 7B, the propulsion system 130 may translate the system 100 from a first location 706 to a second location 708 on the user object 704. In this example, the location may correspond to a position of the system 100 on the user 702. The user object 704 may be a body part of the user 702. For example, the user object 704 may be a back of the user 702, a chest of the user 702, a leg of the user 702, an arm of the user 702, or the like.

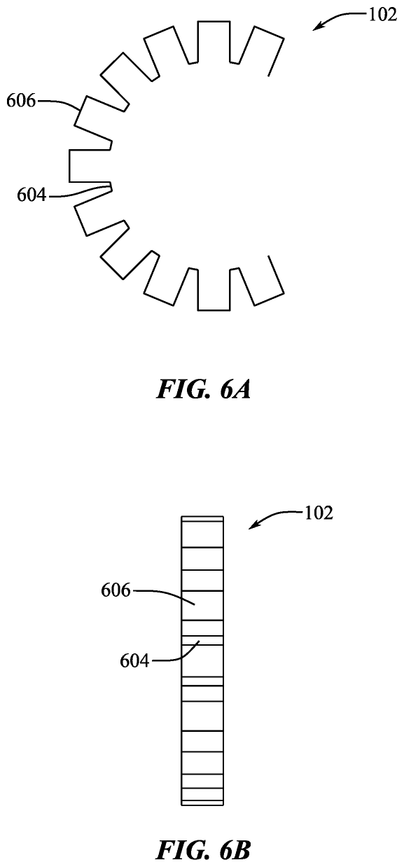

As depicted in FIGS. 6A and 6B, the wheels 102a-d may each include an outer surface 604. The outer surface 604 of the wheel 102 may include a plurality of ridges 606. The plurality of ridges 606 may provide a sensory experience. For example, the system 100 may move on or along the user object 704, e.g., via the propulsion system 130, and the plurality of ridges 606 may provide a sensory experience. For example, as the wheel 102 rotates and each ridge of the plurality of ridges 606 engages with or touches the user object 704, the user 702 may experience a calming sensation. In this way, the sensory experience delivered by the plurality of ridges 606 may help calm the user 702 during an episode of PTSD. The wheels 102a-d may include or may be any suitable material such as rubber, plastic or composite material, and the like.

Referring to FIG. 2, the system 100 may include at least one sweeper 110. For example, the sweeper 110 may include or may couple with the body 124. The sweeper 110 may include a rubber brush, rubber bristles, and the like. The sweeper 110 may contact the user object 704, e.g., as the system 100 translates from the first location 706 to the second location 708. In this way, the sweeper 110 may provide a sensory experience, e.g., as the system 100 translates from the first location 706 to the second location 708. For example, as depicted in FIG. 2, the sweeper 110 may couple with a rear portion of the body 124 and the sweeper 110 may trail behind the body 124 and contact the user object 704 as the system 100 translates. In this way, the sweeper 110 may enhance the sensory experience delivered to the user 702 by the system 100. The sweeper 110 may be or may include any suitable materials such as rubber, plastic, fabric materials, and the like.

The system 100 may include at least one sensor 126. The sensor 126 may be or may include at least one, infrared (“IR”) sensor, capacitive sensor, tilt sensor, ultrasonic sensor, LIDAR sensor, cameras, or the like. The sensor 126 may determine a location of the body 124 or the attachment 112 discussed below. The location may correspond to a position of the body 124 or the attachment 112 on or with respect to the user object 704. The sensor 126 may determine the location of a stationary object, obstacle, or boundary that may be encountered by the system 100. The sensor 126 may facilitate operation of the system 100 or portions of the system 100, such as the propulsion system 130. For example, the sensor 126 may detect a situation that may inhibit or impede the operations of the system 100, such as a boundary line of the user object 704. The sensor 126 may send data to the processor 128, discussed below, and the processor 128 may execute instructions based on the data that prevent or inhibit the propulsion system 130 from translating the system 100 off the user object 704 or user 702. In this way, the sensor 126 may assist the system 100 in delivering a sensory experience to the user 702. For example, since the sensor 126 may facilitate navigation of the system 100, the system 100 may operate autonomously, e.g. without the user 702 or another party manually maneuvering the system 100, e.g., during operation or translation of the body 124, to deliver the sensory experience. The autonomous operation of the system 100 may help calm the user 702 during a PTSD episode or may relieve the anxiety, stress, and/or panic attributable to PTSD.

The system 100 may include at least one processor 128. The processor 128 may be in communication with at least one portion of the system 100, such as the sensor 126, the propulsion system 130, the mode selector 106, the timer 108, and the like. For example, the processor 128 may transmit and receive data, instructions, including program, e.g., application code. For example, the processor 128 may receive information or data from the sensor 126 and may output or send information or data to the propulsion system 130. For example, the sensor 126 may detect an obstacle, such as a boundary or edge of the user object 704, and provide data, such as a distance between the wheel 102 and the boundary of the user object 704, to the processor 128. The processor 128 may in turn transmit instructions to the propulsion system 130 based on the distance data received from the sensor 126. For example, the instructions may include navigation instructions, such as a turn radius or distance to reverse, to prevent or inhibit the system 100 from crossing the boundary of the user object 704. In another example, prior to the movement of the system 100, the processor 128 may transmit instructions to the propulsion system 130 based on a predetermined path, mode, or duration for the system 100 to operate. For example, the system 100 may include or may be in communication with at least one memory system or database and prior to operation of the system 100, the user 702 may upload a map of the user object 704. In one example, the processor 128 may generate the predetermined path based on the map of the user object 704. In another example, the user 702 may select the predetermined path. In yet another example, the processor 128 may transmit instructions to the propulsion system 130 based on input from the user 702 during operation of the system 100.

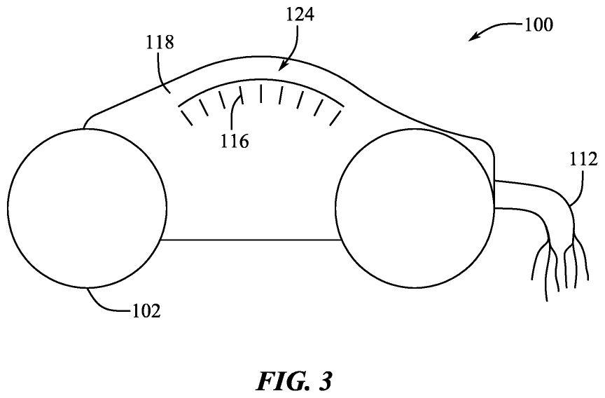

FIG. 3 illustrates an example of a side view of the system 100. The system 100 may include at least one attachment 112. The attachment 112 may couple, e.g., removably couple, with system 100. In another example, the attachment 112 may permanently couple with the system 100. In one example depicted in FIG. 3, the attachment 112 may couple with the system 100 at a rear portion of the body 124. In this way, the system 100 may translate from the first location 706 to the second location 708 and the attachment 112 may trail behind the body 124 and contact the user object 704. The attachment 112 may deliver a sensory experience to the user 702, e.g., as the system 100 translates from the first location 706 to the second location 708. For example, the attachment 112 may provide a calming motion or sensation, such as scratching, massaging, tickling, brushing, tapping, rubbing, stroking and the like, to the user 702.

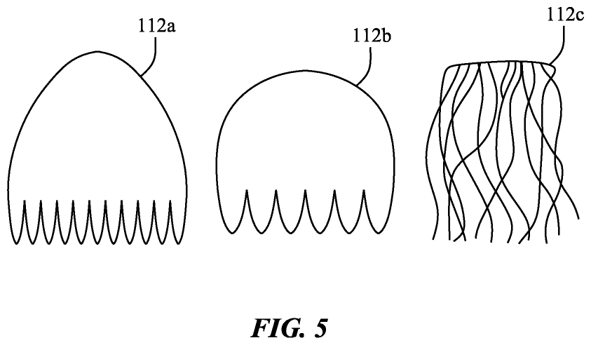

FIG. 5 illustrates examples of the attachment 112. The system 100 may include a plurality of attachments, such as a first attachment 112a, a second attachment 112b, and a third attachment 112c. Each attachment 112, 112a-c may be or may include, a brush attachment, a comb attachment, a feather attachment, and the like. Each attachment 112, 112a-c may be or may include any suitable material, such as feathers, plastic, rubber, composite, nylon, and the like. For example, each of the attachments 112a-c may include a different material, respectively, which may facilitate the system 100 to provide different sensory experiences, such as varied pressures and sensations. In this way, the user 702 may select one of the attachments 112a-c, e.g., based on a symptom or side effect of PTSD or an episode of PTSD. For example, the symptoms or side effects of PTSD may vary, and certain sensory experiences, such as delivered via scratching, may better address certain symptoms or side effects compared to other sensory experiences, such as delivered via tickling.

Each of the attachments 112a-c may couple with a portion of the system 100. For example, each of the attachments 112a-c may simultaneously couple with the system 100 at different locations. In another example, each of the attachments 112a-c may removably couple with the system 100 at the same location. In this example, the attachments 112a-c may be a plurality of interchangeable attachments. For example, the plurality of attachments 112a-c, may include or define similar or the same dimensions. In one example, the first attachment 112a may removably couple with the system 100 and the user 702 may replace the first attachment 112a with the second attachment 112b that may also removably couple with the system 100. The interchangeability of the plurality of attachments 112a-c may facilitate different sensory experiences such that the sensory experience delivered to the user 702 by the system 100 may be customized by the user 702.

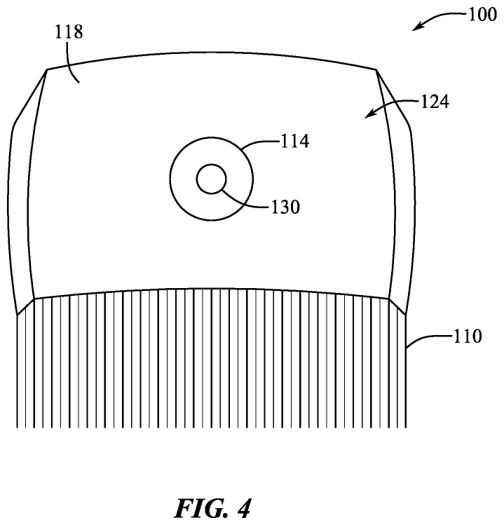

With reference to FIG. 4, the system 100 may include at least one adapter port 114. For example, the adapter port 114 may be defined by the body 124. The adapter port 114 may enable or facilitate the attachment 112 to removably couple with the system 100. For example, each attachment of the plurality of attachments 112a-c may couple with the system 100 at the location of the adapter port 114. The adapter port 114 may include at least one connection mechanism 130. The connection mechanism 130 may be or may include, a magnet connection, latching mechanism with a push button release, a press fit connection, a snap fit connection, a screw connection, or the like. For example, the adapter port 114 may include a first magnet adapter mechanism 130 that may orient in a North Pole orientation and the attachment 112 may include a second magnet adapter mechanism that may orient in a South Pole orientation that couples with the first magnet adapter mechanism 130. In this example, the user 702 may remove or interchange the attachment 112 via pulling the attachment 112 to overcome the magnetic attraction between the first magnet adapter mechanism 130 and the second magnet adapter mechanism. In this way, the connection mechanism 130 may enable the interchangeability of the attachments 112a-c

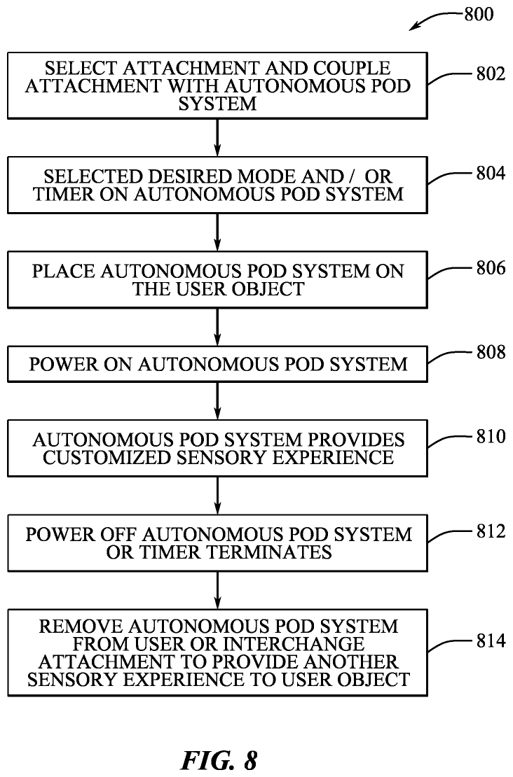

FIG. 8 is a flow chart illustrating a method 800 of operating an autonomous pod system 100 on a user object 704. In methodologies directly or indirectly set forth herein, various steps and operations are described in one possible order of operation but those skilled in the art will recognize the steps and operation may be rearranged, replaced or eliminated without necessarily departing from the spirit and scope of the present disclosure. It is intended that all matter contained in the below description or shown in the accompanying drawings shall be interpreted as illustrative only and not limiting. Changes in detail or structure may be made without departing from the spirit of the present disclosure as defined in the appended claims.

Referring to FIG. 8, the user 702 may select an attachment 112, 112a-c that may provide a sensory experience to the user object 704 (Block 802). The user 702 may select the attachment 112 and couple the attachment 112 with the body 124 of the system 100, e.g., via the connection mechanism 130. The user 702 may select a duration of operation via the timer 108 or a mode via the mode selector 106, e.g., to customize the sensory experience (Block 804). The user 702 may select a timer duration via the timer 108 and the system 100 may provide a sensory experience for a corresponding amount of time. The user 702 may select a mode via the mode selector 106. For example, the mode selector 106 may include, various speed modes, oscillating mode, scratching mode, tapping mode, rubbing mode, tickling mode, and the like, that may be selected using the mode selector 106. The method 800 includes the user 702 or other party placing the system 100 on to the user object 704 (Block 806). The user object 704 may be a back of the user 702, a chest of the user 702, a leg of the user 702, an arm of the user 702, or the like.

The user 702 may power the system 100 on utilizing the power selector 104 (Block 808). The power selector 104 may include, a pushbutton switch, a toggle switch, rotary switch, rocker switch, or latching buttons, or the like. The system 100 may provide a sensory experience to the user object 704 that is customized by the user 702 (Block 810). For example, the system 100 may provide a sensory experience that may calm the user 702 during an episode of PTSD. The system 100 may continue to provide a customized sensory experience to the user object 704 until the user 702 powers off the system 100 or the timer duration terminates, which may power off the system 100 (Block 812). The user 702 may remove the system 100 from the user object 704 (Block 814). The user 702 may still experience anxiety and stress related from a PTSD episode and the user 702 may repeat the process or move the system 100 to a different user object 704 and repeat the process to continue the sensory experience (block 814). The user 702 may also change the attachment 112 that may couple with the body 124. For example, the user 702 may desire a different sensory experience and benefit from the attachments 112a-c that may removably couple with the body 124. The user 702 may interchange a first attachment 112a with a second attachment 112b, that may provide a different sensory experience to the user object 704. The user 702 may place the system 100 back on the user object 704 to experience a different customizable sensory experience. It should be understood that logical operations may be performed in any order, unless explicitly claimed otherwise or a specific order is inherently necessitated by the claim language. Additionally, some of the operations described may be skipped or not included in the method 700.

It should be noted that any of the features in the various examples and embodiments provided herein may be interchangeable and/or replaceable with any other example or embodiment. As such, the discussion of any component or element with respect to a particular example or embodiment is meant as illustrative only.

All directional references (e.g., upper, lower, upward, downward, left, right, leftward, rightward, top, bottom, above, below, vertical, horizontal, clockwise, and counterclockwise) are only used for identification purposes to aid the reader's understanding of the examples of the present disclosure, and do not create limitations, particularly as to the position, orientation, or use of the present disclosure unless specifically set forth in the claims. Joinder references (e.g., attached, coupled, connected, joined and the like) are to be construed broadly and may include intermediate members between the connection of elements and relative movement between elements. As such, joinder references do not necessarily infer that two elements are directly connected and in fixed relation to each other.

In some instances, components are described by reference to “ends” having a particular characteristic and/or being connected with another part. However, those skilled in the art will recognize that the present disclosure is not limited to components which terminate immediately beyond their point of connection with other parts. Thereby, the term “end” should be broadly interpreted, in a manner that includes areas adjacent rearward, forward of or otherwise near the terminus of a particular element, link, component, part, member or the like. In methodologies directly or indirectly set forth herein, various steps and operations are described in one possible order of operation but those skilled in the art will recognize the steps and operation may be rearranged, replaced or eliminated without necessarily departing from the spirit and scope of the present disclosure.

The terms “about” and “substantially” herein are to be construed as +/−10%, unless stated otherwise. Every range of values (of the form, “from about a to about b,” or, equivalently, “from approximately a to b,” or, equivalently, “from approximately a-b” or, equivalently, “greater than about a and less than about b”) disclosed herein is to be understood to set forth every number and range encompassed within the broader range of values.

It is intended that all matter contained in the above description or shown in the accompanying drawings shall be interpreted as illustrative only and not limiting. Changes in detail or structure may be made without departing from the spirit of the present disclosure as defined in the appended claims.

1. An autonomous pod system comprising;
a body;
an attachment configured to couple with the body and contact a user object; and
a sensor configured to determine a location of the body or the attachment.

2. The autonomous pod system of claim 1, wherein the location corresponds to a position of the body or the attachment on the user object.

3. The autonomous pod system of claim 1, further comprising an adapter port defined by the body, wherein the attachment is configured to couple with the adapter port.

4. The autonomous pod system of claim 1, further comprising an adapter port defined by the body, wherein the attachment is a first attachment of a plurality of attachments and each attachment of the plurality of attachments is configured to removably couple with the adapter port.

5. The autonomous pod system of claim 1, further comprising a propulsion system coupled with the body and configured to translate the body on the user object.

6. The autonomous pod system of claim 5, wherein the propulsion system includes a wheel and the wheel includes a plurality of ridges formed on an outer surface of the wheel.

7. The autonomous pod system of claim 1, further comprising a timer or a mode selector.

8. The autonomous pod system of claim 1, further comprising a sweeper coupled with the body and configured to contact the user object.

9. A system for delivering a sensory experience to a user, the system comprising:
a body configured to translate on a user object;
a plurality of interchangeable attachments, wherein each attachment of the plurality of interchangeable attachments is configured to removably couple with the body and contact the user object when coupled with the body;
a sensor configured to determine a position of the body with respect to the user object; and
a processor in communication with the sensor and configured to translate the body from a first location to a second location based on the position of the body.

10. The system of claim 9, further comprising an adapter port defined by the body, wherein each attachment of the plurality of interchangeable attachments is configured to removably couple with the adapter port.

11. The system of claim 9, further comprising a propulsion system coupled with the body and configured to translate the body on the user object.

12. The system of claim 11, wherein:
the propulsion system includes a wheel;
the wheel includes a plurality of ridges formed on an outer surface of the wheel; and
each ridge of the plurality of ridges extends circumferentially around the wheel.

13. The system of claim 9, further comprising a timer or a mode selector.

14. The system of claim 9, further comprising a sweeper coupled with the body and configured to contact the user object.

15. An autonomous pod assembly comprising:
a body;
an attachment configured to couple with the body and contact a user object;
a plurality of wheels coupled with the body and configured to translate the body on the user object; and
a sensor configured to determine a location of the body on the user object.

16. The autonomous pod assembly of claim 15, further comprising an adapter port defined by the body, wherein the attachment is configured to couple with the adapter port.

17. The autonomous pod assembly of claim 15, further comprising an adapter port defined by the body, wherein the attachment is a first attachment of a plurality of attachments and each attachment of the plurality of attachments are each configured to removably couple with the adapter port.

18. The autonomous pod assembly of claim 15, wherein each wheel of the plurality of wheels includes a plurality of ridges formed on an outer surface of each wheel.

19. The autonomous pod assembly of claim 15, further comprising a timer or a mode selector.

20. The autonomous pod assembly of claim 15, further comprising a sweeper coupled with the body and configured to contact the user object.
